(19) United States
(12) Patent Application Publication
(10) Pub. No.: US 2021/0291588 A1
(43) Pub. Date: Sep. 23, 2021

(54) AXLE ASSEMBLY

(71) Applicant: Dynatrac Production Co., Inc., Huntington Beach, CA (US)

(72) Inventors: Jim McGean, Huntington Beach, CA (US); Gene Lukianov, Huntington Beach, CA (US); Collin Dunner, Huntington Beach, CA (US); Erik Steinholt, Huntington Beach, CA (US)

(21) Appl. No.: 17/206,081

(22) Filed: Mar. 18, 2021

Related U.S. Application Data
(60) Provisional application No. 62/991,214, filed on Mar. 18, 2020.

(51) Int. Cl. B60B 37/02; B60B 27/00; B60B 27/06; B60B 35/18

(52) U.S. Cl. CPC B60B 37/02; B60B 27/001; B60B 27/0078; B60B 27/06; B60B 35/18; B60B 2900/325; B60B 2900/113; B60B 2900/112; B60B 2900/311; B60B 2380/14; B60B 2900/212

(57) ABSTRACT

An improved axle may comprise three design features that, used individually or in combination, may drastically improve axle performance and decrease the likelihood of axle damage and/or deformation resulting from vehicle weight, jounce load, combined cornering load, and/or curb strike load. These three features are: dual opposed tapered roller bearings, increased shaft diameter at the bearings, and reinforced flange back face.

### BACKGROUND OF THE INVENTION

In a motorized vehicle, an axle and/or axle housing assembly may be subject to at least five forces: (a) torque for driving the wheel; (b) vehicle weight; (c) jounce load; (d) combined cornering load; and (e) curb strike load. These forces may be amplified, and the direction of these forces may change, under conditions of high-speed turning, uneven driving surfaces, and/or when the weight of the vehicle is not directed through the bottom of the center of the wheel. Such conditions often occur when recreational vehicles, e.g., Jeeps, are used for off-roading such as driving on rocky, angled, and/or uneven terrain. Vehicle modifications, e.g., increased engine output torque, increased wheel and tire size, negative wheel offset, increased payloads, increased numerical gear ratios, and accessories/modifications that add weight (e.g., heavier exterior bumpers, body protection, skid plates, and additional off-road and recovery equipment), may further amplify these forces.

Semi-float and full-float are two axle designs commonly used to address the forces on the axle and axle housing assembly. FIG. 1 shows a cross section of an exemplary semi-float design 100.

As shown in FIGS. 1 and 2, in a conventional semi-float axle design, vehicle weight and road loads (jounce load, combined corning load, and curb strike load) act on the wheel on hub 110 (which is the end of the axle shaft 120), resulting in inward and upward forces 194 (vehicle weight and jounce load), 196 (combined cornering load), and 198, and the contact point at bearing assembly 130 acts as a reaction or pivot point. As shown in FIG. 2, when the forces of vehicle weight and jounce load 194 are applied to axle assembly 100, the result is a spatial deflection force 210 along the segment of the axle shaft 120 between bearing assembly 130 and differential box 140 (or gear box or other component that may constitute in inner terminating end of the axle shaft). This design is generally sufficient for modest-sized passenger vehicles that are used for routine on-road travel, light-duty trucks, and light-to-medium duty off-road vehicles. For such vehicles and use conditions, a semi-float axle is generally sufficient to prevent permanent deformation (often manifested as permanent bending in the mid-section of the axle shaft).

But semi-float axles have limitations. Conventional semi-float axles are typically designed for and come standard on tires with a maximum diameter of 31-32 inches. But consumers routinely install after-market tires that have become progressively larger-often over 40 inches in diameter. Increased tire diameter also results in significantly increased tire weight and rotating mass. Additionally, larger tire sizes-especially in after-market installations-often introduce or increase negative offset (i.e., the center of the tire is outside of the wheel mounting point). Negative offset exaggerates the forces applied to a semi-float axle because the outside edge of the tire is further from the mounting point, thereby increasing the leverage of the forces applied through the mounting point.

Although generally sufficient for the modestly sized passenger vehicles in non-extreme driving conditions, semi-float axles are insufficient for heavy trucks, semis, and smaller vehicles used for extreme off-roading. For off-road vehicles for extreme off-roading, modifications that increase the forces on the axle and/or bearing assembly and high-force usage expose the weaknesses of a semi-float axle design.

The combination of some or all of the forces described above (vehicle weight, jounce load, combined cornering load, curb strike load, and torque) on a semi-float axle may result in one or more failures including but not limited permanent bending/deformation of the axle shaft and permanent bending/deformation of the axle flange. Field research, testing, and experience suggest that the typical failure from these forces is permanent bending in the mid-section of the axle shaft, i.e., bending on the segment between the bearing housing/assembly and the differential box. Flange bending may result from sudden and sharp curb strikes.

FIG. 2 illustrates the forces that cause an axle shaft to bend, and FIG. 3 illustrates the result of a permanent bend. As shown in FIG. 2, when axle 100 is subject to vehicle weight and jounce load 194, a reaction point 180 in the middle of shaft 120 at the location of hub assembly 110 results in a bend at bend point 215.

As shown in FIG. 3, if the forces are sufficiently strong, a permanent bend 315 results in axle shaft 120.

The single axle bearing conventionally used in a semi-float axle acts as a pivot point about which the forces on the wheel/tire react. Road/object impact combined with vehicle weight and rotating torque forces tends to bend the middle of the axle shaft. Once the shaft centerline is no longer straight it orbits the intended axis of rotation instead of following it. The axle flange, brake rotor, and in turn, the wheel, may exhibit runout (wobbling). Such orbiting is also detrimental to the life of the axle bearing, which is no longer able to rotate freely in a single plane. The life of the oil seal is also affected because the seal journal on the axle shaft operates in a state of runout.

Such permanent bending/deformation in the axle shaft is frequently manifested as wheel wobble and/or brake noise from rotor runout rubbing the brake pads intermittently.

Such failure, i.e., bending and deformation is generally unrepairable and requires replacement of the compromised parts and related assemblies. This can be quite expensive.

Stronger materials and increased axle diameter may provide some marginal increase in resistance to permanent bending/deformation, but fail to satisfactorily address these shortcomings in the semi-float design.

A full-float axle design remedies some of shortcomings of the semi-float design. As shown in FIG. 4, a full-float axle design uses a two-bearing spindle-and-hub configuration to separate the vehicle weight and road loads from the axle torsion load. The axle shaft is responsible only for transmitting rotation torque—but is insulated from vehicle weight and road loads (jounce, combined cornering, and curb strike). The vehicle weight and road loads are transferred away from the bearing assembly/housing, via a spindle and reinforced rigid axle housing, to the center of the underside of the vehicle at or near the differential box.

As shown in FIG. 4, axle shaft 450 rotates hub 440 (wheel is mounted at wheel-mounting surface 442 using threaded studs/bolts 444a-n), but the vehicle weight and jounce load 490, combined cornering load 492, and curb strike load 494 are all transferred through spindle 420 and rigid axle housing 425 away from axle 450, to the center of the underside of the vehicle at or near the differential box.

Full-floating axles have been found to be effective in handling large tire diameters, heavier payloads, and greater abuse than semi-float axles, and are commonly found in heavy-duty trucks, semis, and extreme off-roading vehicles.

Although a full-float design is generally effective at preventing permanent bending/deformation, this design is subject to several drawbacks that detract from its usefulness and/or practicality for a recreational off-roading vehicle. First, full-float axles are more expensive to manufacture, purchase, and install. The added expense is even greater in a retrofit application. Second, full-float axles are heavy, resulting in higher un-sprung weight that degrades suspension performance, reduces ride comfort, and possibly requires shock absorber upgrade or replacement. The weight of a full-float axle may also decrease fuel economy and/or increase GHG (greenhouse gas) output.

Third, because full-floating axles require wheel bolt patterns that are not compatible with the wheel bolt patterns on light trucks, SUVs, and off-road vehicles (standard or after-market), upgrading to a rear full-float axle requires replacement of the front axle and new wheels so that all four wheels match (practicality and usefulness dictate that all four wheels/tires, as well as a spare wheel/tire, should be interchangeable among all wheel positions on a vehicle. The expense of four new tires, four new wheels, and installing (mounting and balancing/aligning) the four new wheels and tires is considerable. The inconvenience is also considerable.

Another potential approach is a tapered-diameter semi-float axle shaft which employs a thicker axle (larger axle diameter) near the hub and reaction point, which then tapers to a smaller diameter axle toward the middle of the underside of the vehicle, i.e., toward the differential box or gear box. In a tapered design, the axle shaft diameter is tapered from a large diameter at the flange or bearings to a smaller diameter at the opposite end where the axle shaft engages the differential. The taper may be uniform, graduated (stages or staggers), or a combination of such. FIG. 5 shows a cross section of an exemplary tapered semi-float design with a graduated taper. Axle 520 may comprise three axle segments having different diameters: 522, 524, and 526. Axle segment 522, which is closest to hub 510, may have the largest diameter. At axle diameter reduction point 523, the diameter of axle 520 may decrease for axle segment 524. At axle diameter reduction point 525, the diameter of axle 520 may decrease for axle segment 526.

But the tapered design suffers from at least two drawbacks. First, the maximum axle shaft diameter is limited to the inner diameter of the bearing assembly/housing. Second, because the taper design places the smallest diameter of the axle shaft at the end axle end where the axle engages the differential, torque loads, weight, and road loads concentrate at this location, and the tapered axle shaft is likely to fail at or near this location. Uniformity (or increased uniformity) of the axle shaft diameter distributes the torque forces across a longer segment of the axle shaft, resulting in greater ductility for shock absorption. In the tapered design, non-uniform shaft diameter compromises the force distribution.

What is needed is an improved axle design that prevents or decreases the likelihood of axle deformation, avoids unnecessary premature wheel and tire upgrades, is simpler and less expensive to manufacture and install than a full-float axle, and avoids unnecessary weight.

### BRIEF SUMMARY OF THE INVENTION

An improved axle assembly for a vehicle may comprise a combination of one or more of the following three features: dual opposed tapered roller bearings, increased shaft diameter at the bearings, and reinforced flange back face.

Dual opposed tapered bearings may have several benefits: increased total bearing radial load capacity, additional support for the axle shaft in contact with the bearing assembly, and increased rigidity of the axle shaft in contact with the bearing assembly. The dual-bearing design distributes vehicle weight and road loads over the length of the entire dual-bearing assembly instead of over just the width of one bearing as in a single bearing design.

Using a larger shaft diameter (relative to the shaft segment from the bearing assembly to the differential) at or near the bearing assembly may provide several benefits: (i) torque forces are transferred to the longer smaller-diameter shaft segment, thereby increasing the length of the shaft segment over which torque forces and resulting deflection are distributed; (ii) shifting torque forces away from the bearing assembly protects the bearing assembly's moving parts and tight tolerances; and (iii) increased diameter of the shaft segment in contact with the bearing assembly necessarily requires a complementarily sized bearing assembly, which results in increased surface contact between the shaft and the bearing assembly, thereby increasing the shaft's resistance to axial deviation.

The reinforced flange back face comprises additional flange material (relative to a conventional flange design) such that the back face of the flange meets each stud head at or near the top of the stud head (or at least above the bottom of the stud head) instead of at or below the bottom of the stud head. A flange reinforced in this manner may resist flange distortion or bending during sharp curb strikes or exposure to other forces that may tend to distort the axle flange.

Using one or more of these features in combination with each other may result in an axle assembly that is significantly stronger than a semi-float axle, but significantly less expensive and less inconvenient than a full-float axle.

### BRIEF DESCRIPTION OF THE DRAWINGS

FIG. 1 shows a cross-section view of an exemplary semi-float axle.

FIG. 2 shows a cross-section view of an exemplary semi-float axle undergoing a displacement along the shaft as a result of a force applied to the hub flange.

FIG. 3 shows a cross-section view of an exemplary semi-float axle that has a permanent shaft bend.

FIG. 4 shows a cross-section view of an exemplary full-float axle.

FIG. 5 shows a cross-section view of an exemplary semi-float axle with a graduated shaft diameter.

FIG. 6a shows a cross-section view of an exemplary improved axle.

FIG. 6b shows front elevated cross-section view of an exemplary improved axle.

FIG. 7 shows a cross-section view of an exemplary improved axle, focusing on forces transmitted through the bearing assembly.

FIG. 8a shows a cross-section view of the hub/flange portion of an exemplary improved axle.

FIG. 8b shows a side view of the hub end of an exemplary improved axle, without the studs for securing the wheel.

FIG. 8c shows a side view of the hub end of an exemplary improved axle, with the studs for securing the wheel.

FIG. 8d shows a rear elevated angle view of the hub end of an exemplary improved axle, without the studs for securing the wheel.

FIG. 8e shows a rear elevated angle view of the hub end of an exemplary improved axle, with the studs for securing the wheel.

FIG. 9a shows an elevated-angle exploded view of an exemplary bearing assembly for an improved axle as described herein.

FIG. 9b shows a cross-section view of an exemplary bearing assembly for an improved axle as described herein.

FIG. 10a shows an elevated-angle rear exploded view of an improved axle as described herein.

FIG. 10b shows an elevated-angle rear view of an improved axle as described herein.

FIG. 10c shows a front elevated-angle partially-exploded view of an improved axle as described herein.

FIG. 10d shows a rear elevated-angle view of an exemplary improved axle as described herein.

FIG. 10e shows a front elevated-angle exploded view of an exemplary improved axle as disclosed herein.

FIG. 10f shows a front close-up elevate angle view of an exemplary improved axle as disclosed herein.

FIG. 11 shows a cross-section view of the hub/flange portion of an exemplary improved axle as described herein. As shown in FIG. 11, the front of the hub/flange has not been “cupped” or hollowed out.

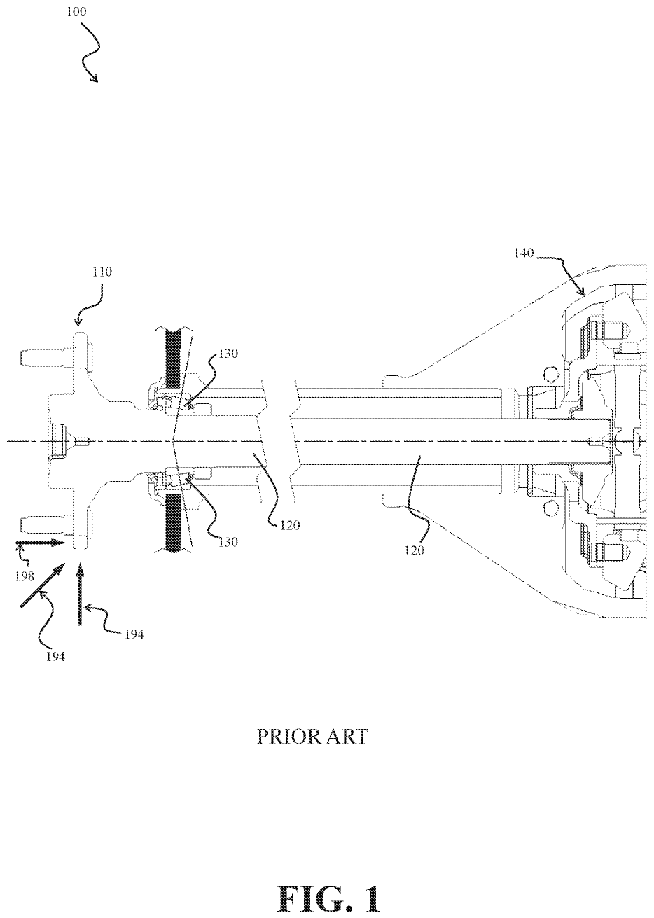

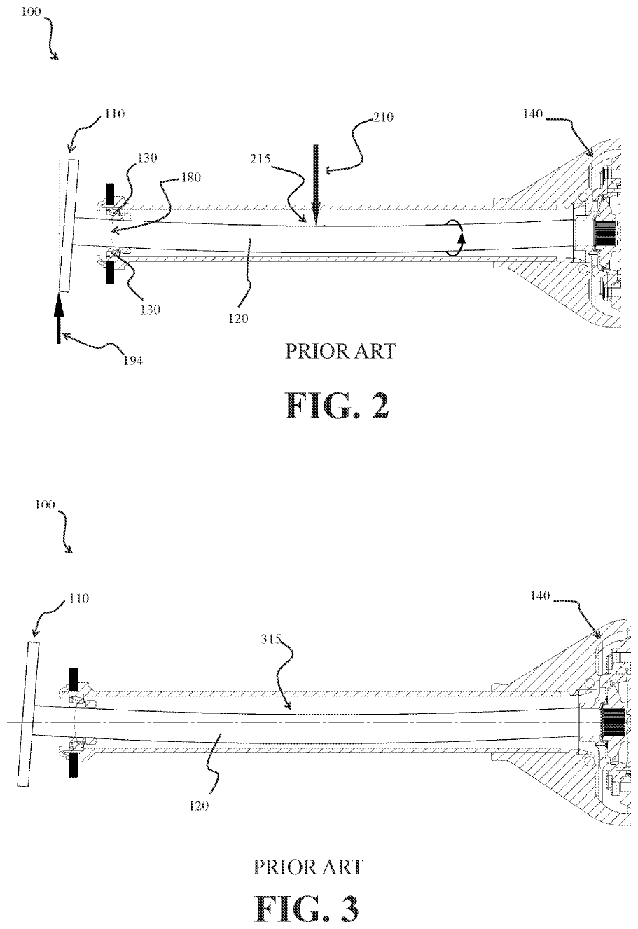

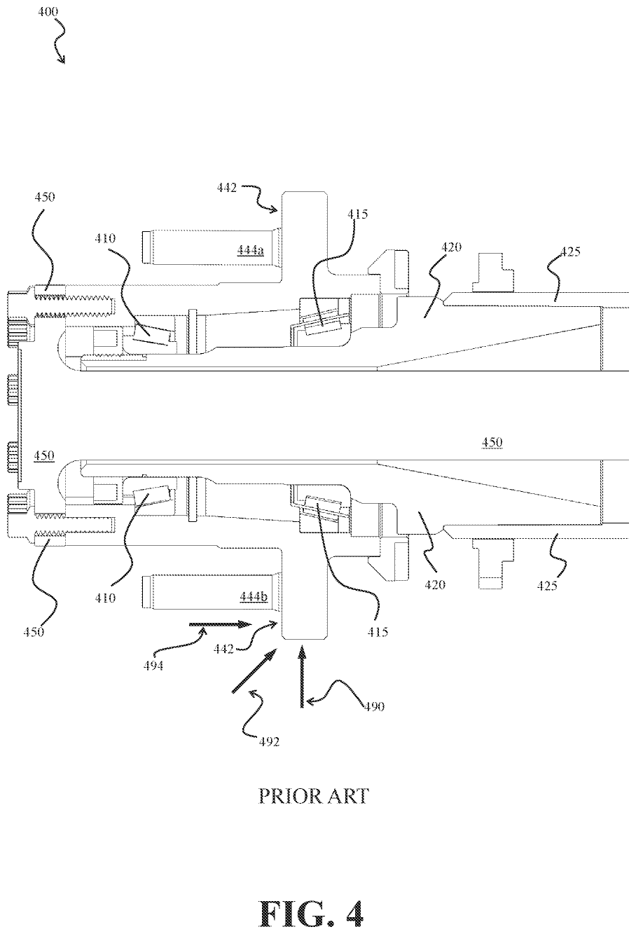

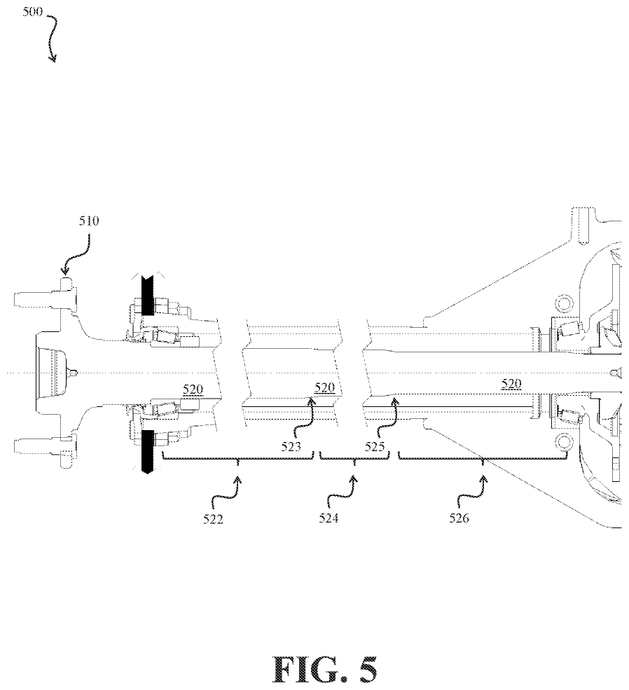

### DETAILED DESCRIPTION OF THE INVENTION

This application claims priority to U.S. Provisional Application No. 62/991,214 filed on Mar. 18, 2020, titled “Axle Assembly,” and the first inventor of which is Jim McGean. This application is incorporated by reference in its entirety.

An improved axle for recreational vehicles and/or other vehicles is disclosed.

### TABLE OF REFERENCE NUMBERS FROM DRAWINGS

The following table is for convenience only, and should not be construed to supersede any potentially inconsistent disclosure herein.

| Reference | |
|---|---|
| Number | Description |
| 100 | semi-float axle assembly |
| 110 | hub |
| 120 | axle shaft |
| 130 | axle bearing assembly |
| 140 | differential box or gear box |
| 180 | reaction point |
| 194 | force of vehicle weight and jounce load |
| 196 | combined cornering load |
| 198 | curb strike load |
| 210 | spatial deflection force along axle shaft |
| 215 | bend point on axle shall |
| 310 | permanent bend in axle shaft |
| 400 | full-float axle assembly |
| 410 | outer bearing assembly |
| 415 | inner bearing assembly |
| 420 | spindle |
| 425 | rigid axle housing |
| 440 | hub |
| 442 | wheel-mounting surface |
| 444a-n | threaded stud/bolt |
| 450 | axle shaft |
| 490 | vehicle weight and jounce load |
| 492 | combined cornering load |
| 494 | curb strike load |
| 500 | tapered semi-float axle assembly |
| 510 | hub |
| 520 | axle shaft |
| 522 | segment of axle shaft |
| 523 | axle diameter-eduction point |
| 524 | segment of axle shaft |
| 525 | axle diameter reduction point |
| 526 | segment of axle shaft |
| 530 | axle bearing |
| 540 | differential box or gear box |
| 580 | reaction point |
| 594 | force of vehicle weight and jounce load |
| 596 | combined cornering load |
| 598 | curb strike load |
| 600 | improved axle assembly |
| 605 | axle |
| 610 | segment of axle from transition segment to |
| | differential box |
| 620 | transition segment of axle |
| 622 | small diameter end of axle transition segment |
| 624 | large diameter end of transition segment |
| 626 | bearing-interface axle segment |
| 629 | transition from shaft to hub/shaft portion of axle |
| 627 | outer surface of bearing-interface axle segment |
| 630 | bearing assembly |
| 632 | differential-side bearing |
| 633 | inner race of differential-side bearing |
| 634 | outer race of differential-side bearing |
| 635 | rollers in differential-side bearing |
| 636 | wheel-side bearing |
| 637 | inner race of wheel-side bearing |
| 638 | outer race of wheel-side bearing |
| 639 | rollers in wheel-side bearing |
| 640 | seal |
| 641 | bearing housing |
| 650 | flange |
| 651 | back flange surface |
| 652 | wheel-mounting surface |
| 653a-n | wheel-mounting bolts/studs |
| 654 | outer edge of flange |
| 655 | inside surface of flange cup |
| 656 | front side of flange |
| 710 | load transferred through differential-side bearing |
| 715 | load point offset from differential-side bearing |
| 720 | load transferred through wheel-side bearing |
| 725 | load point offset from wheel-side bearing |
| 740 | direct downward force |
| 810a-n | stud body |
| 820a-n | stud head |
| 822a-n | bottom of stud head |
| 823a-n | inner side of stud head |
| 824a-n | outer side of stud head |
| 828a-n | top of stud head |
| 850 | mounting plate |
| 852 | washer |
| 854 | set screw |
| 856 | retainer nut |
| 858 | snap ring |
| 860 | O-ring |
| 862 | differential side of axle housing |
| 864 | differential |
| 1100 | hub/flange without frontside cupping |
| 1110 | front side of hub/flange |

An improved axle design is disclosed. The improved axle design combines three design features that, when used together, drastically improve axle performance and decrease the likelihood of axle damage and/or deformation resulting from vehicle weight, jounce load, combined cornering load, and/or curb strike load. These three features are: dual opposed tapered roller bearings with optimized spacing, increased shaft diameter at the bearings, and reinforced flange back face. Although performance is maximized when these three features are used together, use of one or more of these three features may result in performance gains.

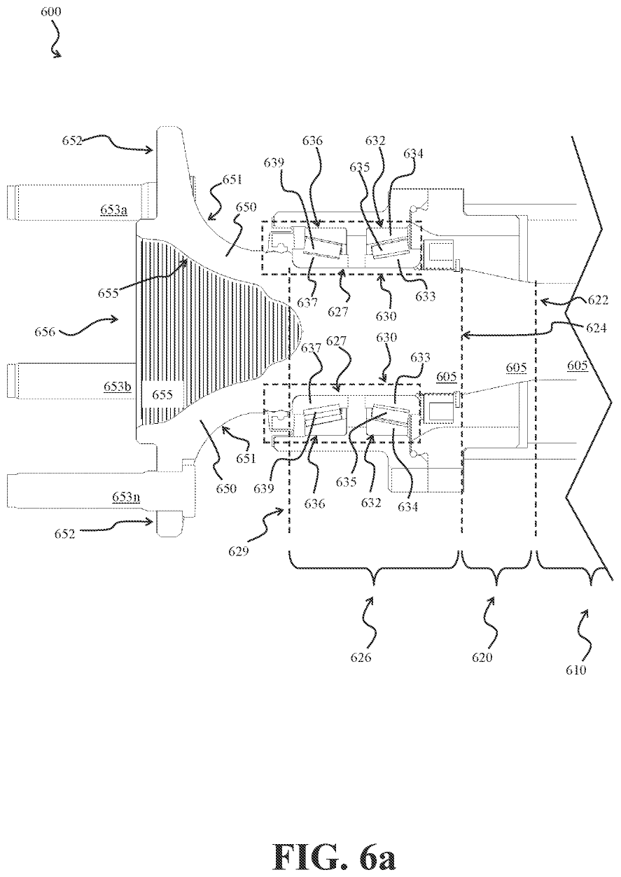

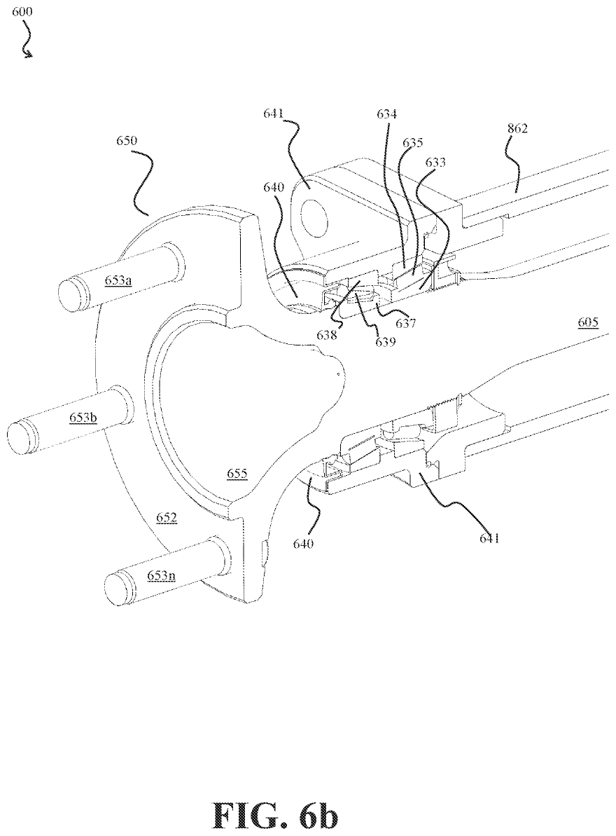

FIG. 6a shows a cross section of an exemplary improved axle. FIG. 6b shows an elevated angle cross-section view of an exemplary improved axle

The dimensions described in the description herein are exemplary. The axle assembly disclosed herein may be scaled or adjusted without departing from the scope of this disclosure.

Axle Shaft Diameter

As shown in FIG. 6a, axle segment 610 may be a shaft made out of steel or any material known in the art for axles and may have a diameter of 1.510 inches. Increasing the diameter of axle segment 610 results in greater strength and rigidity, but also increases weight and cost. Although FIG. 6a shows the axle segment 610 as having a uniform diameter along the entire length of the segment, the axle may have a non-uniform diameter, although non-uniformity of diameter may result in force concentration instead of distribution. Uniform diameter of axle segment 610 promotes ductility and short duration shock absorption to avoid permanent shaft deformation and failure.

Axle transition segment 620 may have a length of 1.344 inches and a diameter of 1.510 inches at small-end 622, and a diameter at large-end 624 of 2.000 inches. The diameter at small-end 622 diameter may be the same as the diameter of axle segment 610, and the large-end 624 diameter may be the same as the diameter of bearing-interface segment 626. Although axle transition segment 620 is shown in FIG. 6a as having a linear transition, i.e., the diameter increases linearly from small end 622 to large end 624, in some embodiments the transition may have a non-linear transition profile.

Bearing-interface axle segment 626 is adjacent to and interfaces with bearing assembly 630. Bearing-interface axle segment 626 may have a length of 2.630 inches and a diameter of 2.000 inches. In one embodiment, the length of bearing-interface axle segment 626 may be approximately the length of bearing assembly 630.

In general, the diameter of bearing-interface axle segment 626 may be equal to the inner diameter of bearing assembly 630, so that outer surface 627 of bearing-interface axle segment 626 interfaces with bearing assembly 630 as shown in FIG. 6a. In general, using a bearing-interface axle segment 626 with a diameter that is larger than the diameter of axle segment 610 (or larger than the minimum diameter of axle segment 610) has several benefits. First, torque forces are transferred to the smaller-diameter segment of axle 605, i.e., to segment 610, and because segment 610 is much longer than segment 626, the torque forces and resulting torque deflection are distributed over a longer segment of axle 605, increasing the ability of axle 605 to dissipate torque deflection without permanent deformation. Second, shifting torque forces protects the bearing assembly 630's moving parts and tight tolerances, which are susceptible to damage that may result from torque deflection in bearing-interface axle segment 626.

Third, increased diameter of bearing-interface axle segment 626 necessarily requires a complementarily sized bearing assembly 630. Increased diameter of bearing-interface axle segment 626, and complementarily increased diameter of bearing assembly 630, results in increased surface contact between bearing-interface axle segment 626 and inner races 633 and 637 of bearing assembly 630, thereby increasing axle 605's resistance to axial deviation.

The length and/or diameter profile of axle segment 626 may be adjusted based on characteristics of a particular application, e.g., overall length of the axle, weight of the vehicle, anticipated vehicle use, size dimensions of vehicle and/or components, anticipated moment forces, and/or any other well-known engineering principles relating to the characteristics of the forces likely to be exerted on the axle at or near the bearings.

Bearing Assembly

Bearing assembly 630 may be a dual angled tapered bearing comprising wheel-side bearing 636 and differential-side bearing 632. As shown in FIG. 6a, bearing 636 and bearing 632 are positioned and oriented as dual opposed tapered roller bearings. Rollers 639 in wheel-side bearing 636 and rollers 639 in differential-side bearing 632 are angled inward to create a cradle-like cross section upon which outer races 634 and 638 move.

Several benefits result from a dual-angled-tapered bearing design: increased total bearing radial load capacity, additional support for bearing-interface axle segment 626, and increased rigidity of bearing-interface axle segment 626. The dual-bearing design distributes vehicle weight and road loads over the length of the entire dual-bearing assembly 630, instead of over just the width of one bearing as in a single bearing design.

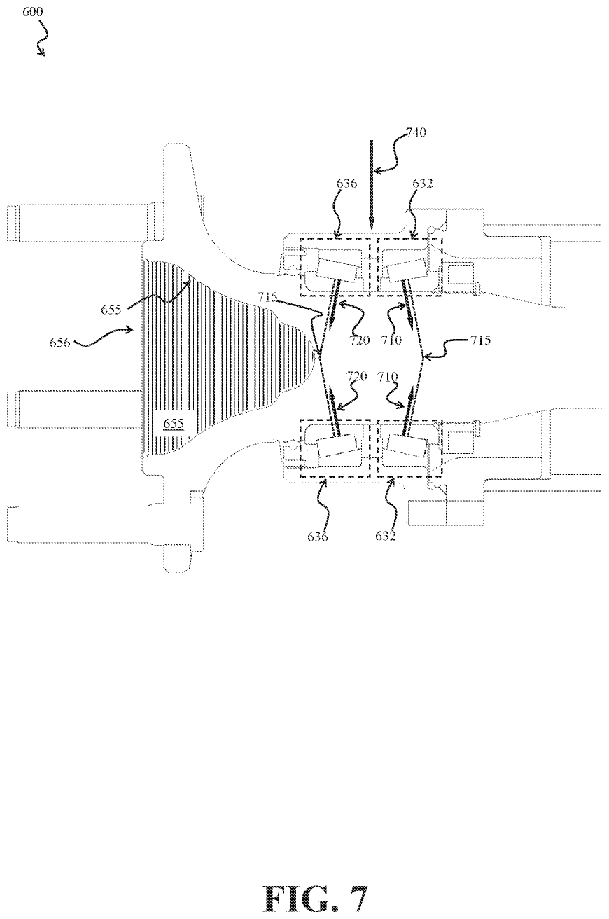

As shown in FIG. 7, the separation between differential-side bearing 632 and wheel-side bearing 636, as well as the angle and tapering of rollers 635 in differential-side bearing 632 and of rollers 639 in wheel-side bearing 636, result in the load directions 710 and 720, and load point offsets 715 and 725. As the distance between load point offset 715 for differential-size bearing 632 and load point offset 725 for wheel-side bearing 636 increases, the vehicle weight and road load transferred through bearing assembly 630 to bearing-interface axle segment 626 are distributed along a longer length of axle segment 605, resulting in increased rigidity along the bearing-interface axle segment 626.

In one embodiment, each of differential-side bearing 632 and wheel-side bearing 636 may have a width of 0.975 inches, and may be separated by 0.263 inches.

Differential-side bearing 632 and wheel-side bearing 636 may each have a width of approximately 0.8750 inches. In general, increasing the distance between differential-side bearing 632 and wheel-side bearing 636 increases distribution along bear-interface axle segment 626 of forces 715 and 725 transferred through bearings 632 and 636 to bearing-interface axle segment 626, thereby decreasing the probability that axle 605 will bend or deform. Increasing the distance between bearings 632 and 636 also increases the rigidity of bearing-interface axle segment 626, thereby decreasing the tendency of bearing assembly 630 to act as a reaction or pivot point spatial deflection of axle 605.

Although the distance between bearings 632 and 636 may be adjusted depending on particular design constraints or on a particular application, the maximum distance is subject to several limitations. First, placement of other components, e.g., the brake assembly, limits the distance between bearings 632 and 636. Second, manufacturing, design, and vehicle assembly considerations limit the distance between bearings 632 and 636. Third, because bearing-interface axle segment 626 may not be perfectly straight, increasing the distance between bearings 632 and 636 amplifies the effect of any deviations from perfect straightness in bearing-interface axle segment. If bearings 632 and 636 are too far apart, the effect of imperfections in the straightness of bearing-interface axle segment 626 may exceed acceptable thresholds. Fourth, manufacturing and alignment tolerances on the bearings 632 and 636 individually, as well as on their alignment relative to each other, tighten as the distance between bearings 632 and 636 increases. Tighter tolerance requirements may increase the cost of manufacturing, or may even be impossible to satisfy.

Although the detailed embodiment described herein includes dual tapered bearings, other bearing designs could be used. For example, ball bearings or straight roller bearings could be used. However, these alternate designs have drawbacks. In a ball bearing design, all vehicle weight and road load are transferred through only one contact point on each ball, thereby placing significant stress on each ball. Also, instead of distributing vehicle weight and road load jounce load along a segment of the axle shaft, in a ball bearing design the vehicle weight and road load are transferred to the one point on the axle that is in mechanical contact with the ball bearing.

A straight roller bearing design (single, dual, or otherwise) has the benefit of distributing forces along a longer length of the axle shaft, but does not provide the stabilization benefits of the tapered angled dual roller bearings. Because straight roller bearings are flat relative the inner and outer races of the respective bearings, the vehicle may slide along the length of the straight roller bearings. Tapered angled roller bearings, on the other hand, cradle the vehicle at the point of the interface between the vehicle weight/forces and the bearings, thereby stabilizing the vehicle so that it cannot slide or move relative to the bearings and shaft.

Additionally, as shown in FIG. 7, because of the angling of bearings 632 and 636, for a direct downward force 740 on bearing assembly 630, bearings 632 and 636 direct the vehicle weight and road load forces 740 outward as forces 715 and 725, thereby distributing these forces over a longer segment of bearing-interface axle segment than the length of the bearing assembly 630 itself. For more complex forces (e.g., combined vehicle weight and road loads), tapered angled roller bearings 632 and 636 in bearing assembly 630 analogously spray the forces over a length of bearing-interface axle segment 626 that is longer than the contact interface between bearing assembly 630 and bearing-interface axle segment 626. Additionally, the combination of angled bearings is naturally suited to arrest lateral thrust forces that hold the shaft in place without the need for differential C-clips, which limit the use of locking, traction aiding, and stronger differentials

In general, bearing assembly 630 may be located as close to the wheel as possible, thereby decreasing the leverage forces exerted on bearing assembly 630 as a pivot point. Axle flange 650 may limit the minimum distance of bearing assembly 630 from the wheel.

Reinforced Flange

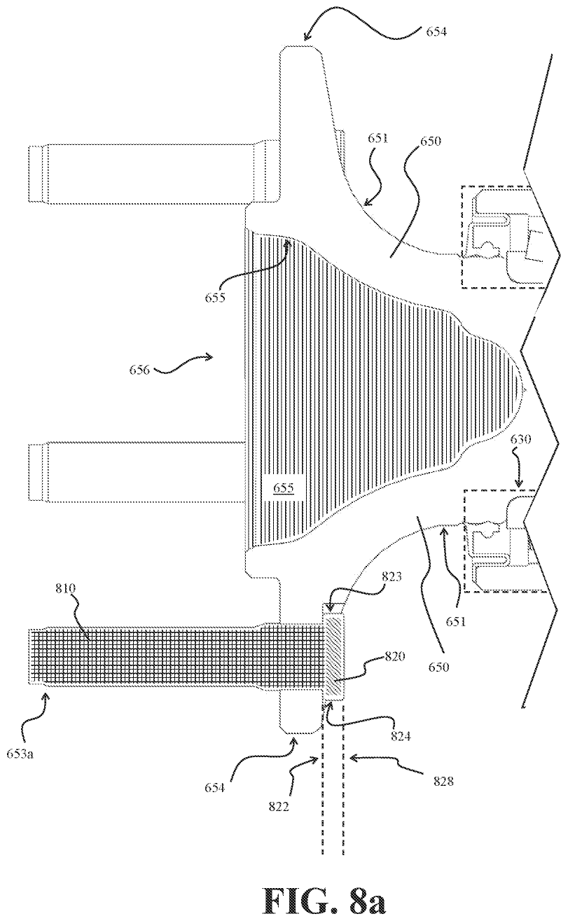

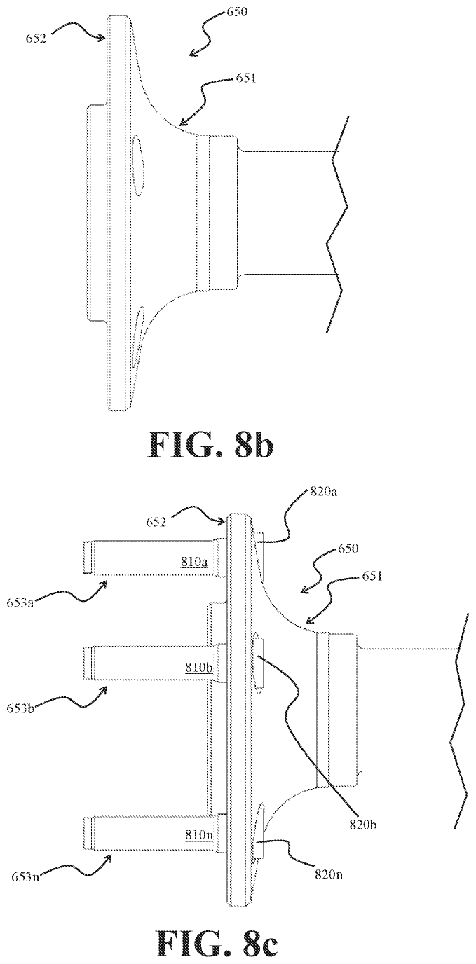

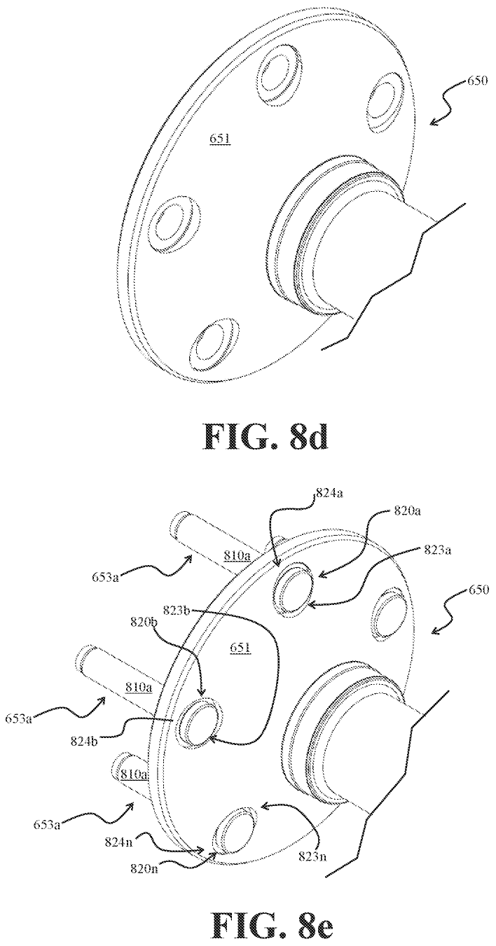

As shown in FIGS. 6-8, curved back surface 651 of axle flange 650 virtually intersects (because back flange surface 651 is recessed at the location of stud head 820, the curve of back flange surface 651, if continued, would “intersect”) with inner side 823 of stud head 820. Intersection with stud head 820, instead of with stud body 810, or “bottom” 822 of stud head 820, allows for use of additional material on back flange surface 651, thereby resulting in a thicker flange as flange transitions from flange outer edge 654 toward bearing assembly 630.

Reinforced flange 650 may resist flange distortion or bending during sharp curb strikes or exposure to other forces that may tend to distort the axle flange.

The shape, curve, or geometry of back flange surface 651 may be curved, functionally curved (e.g., a series linear or other geometries that functionally behaves like a curve), or designed in any other manner so that the thickness of flange 650 requires recessing of back flange surface 651 to accommodate inner side 823 of stud head 820.

The transition between outer side 824 of stud head 820 and back flange surface 651 may or may not require a transition.

The reinforced flange 650's tapered back face also resists increased loads at the flange resulting from the improved stiffness and axial rigidity of the remainder of shaft 605 and bearing assembly 630. The backside surface 651 of flange 650 is tapered toward bearing assembly journal 630 to provide increased flange support and spread impact loads evenly throughout axle segments 610, 620, and 610, 626. This also helps to transfer impact forces to the large diameter body of bearing-interface axle segment 626.

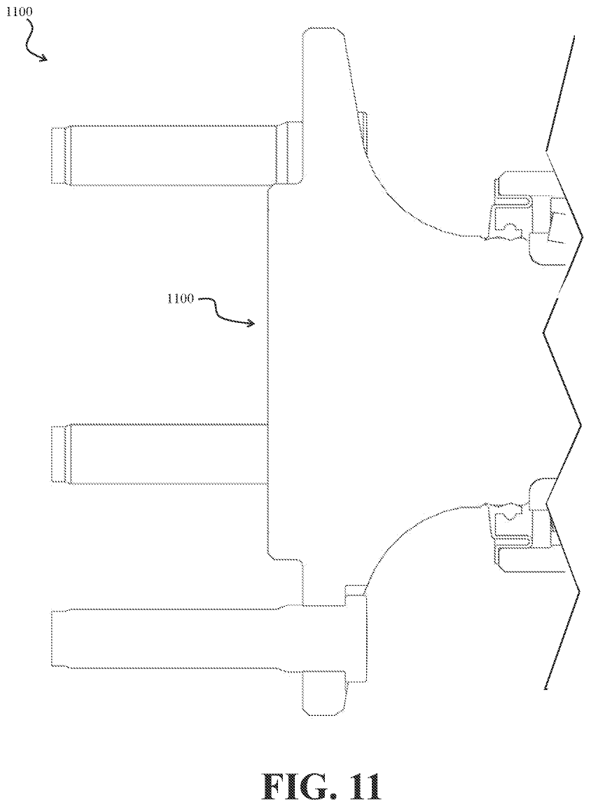

As shown FIGS. 6-8, front side 656 of flange 650 may be cupped in the center as shown by inside cup surface 655. Cupping or other patterns for material removal from front side 656 of flange 655 may result in less weight. In other embodiments, front side 656 of flange 650 may not be cupped at all, or may employ a different pattern for material removal. FIG. 11 shows an exemplary hub/flange 1100 in which front side 1110 is not cupped at all.

Assembly

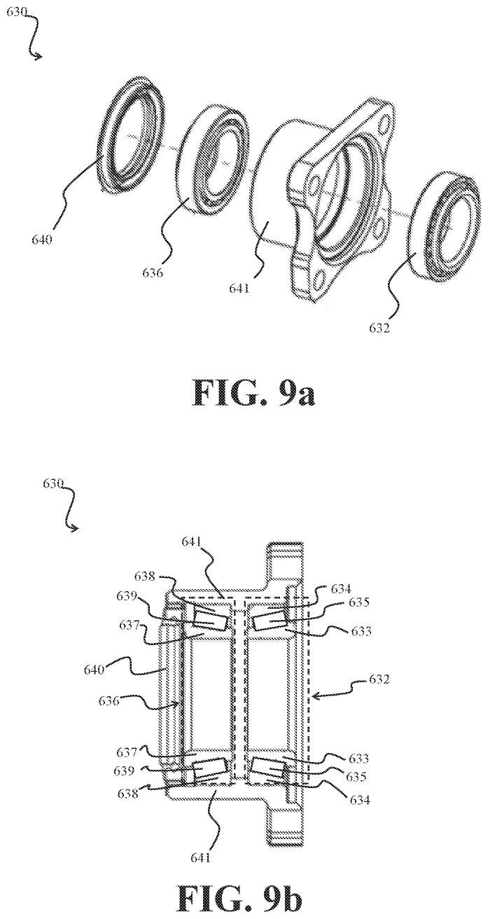

FIG. 9a is an exploded elevated angle view of an exemplary bearing assembly 630. As shown in FIG. 9, bearing assembly 630 may comprise seal 640, wheel-side bearing 636, bearing housing 641, and differential-size bearing 632.

FIG. 9b is a cross-section view of an exemplary bearing assembly 630. As shown in FIG. 9, bearing assembly 630 may comprise seal 640, wheel-side bearing 636, bearing housing 641, and differential-side bearing 632.

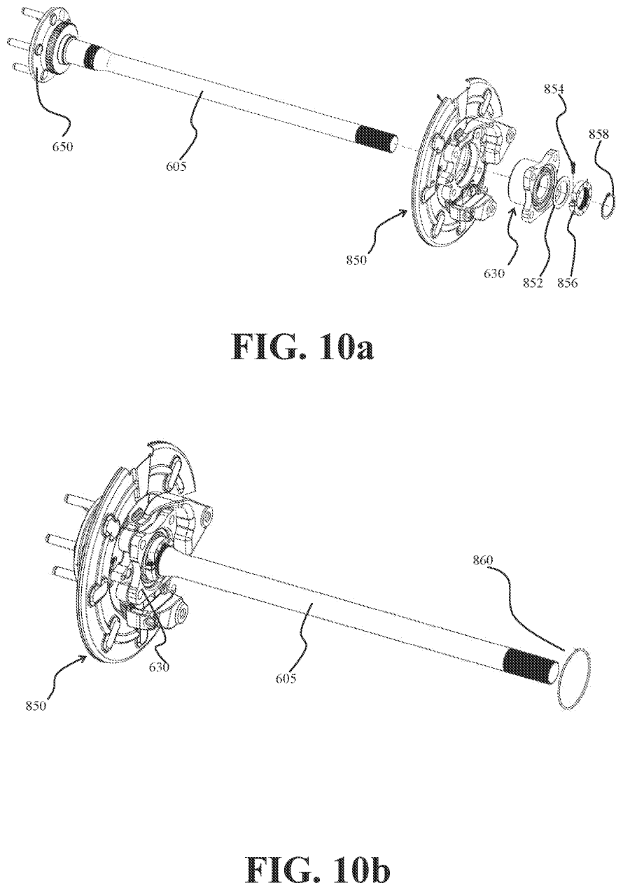

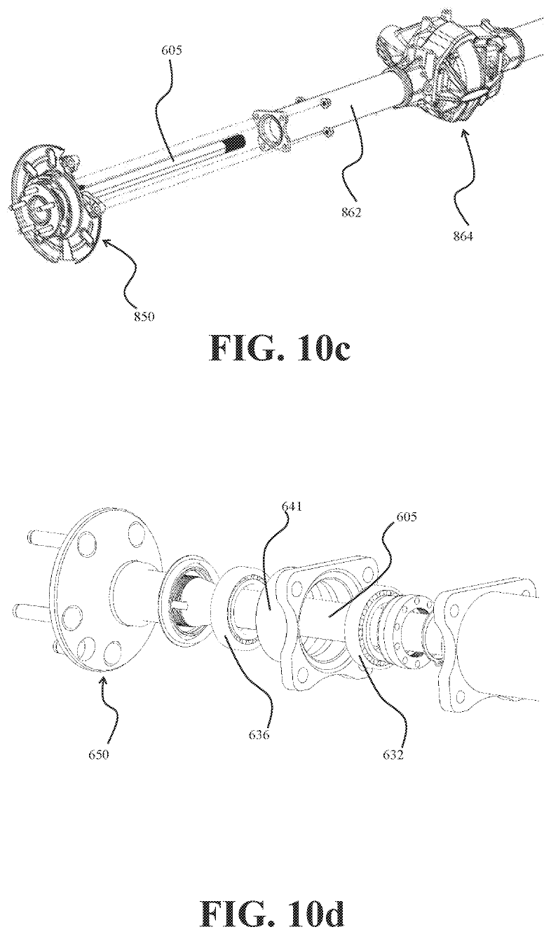

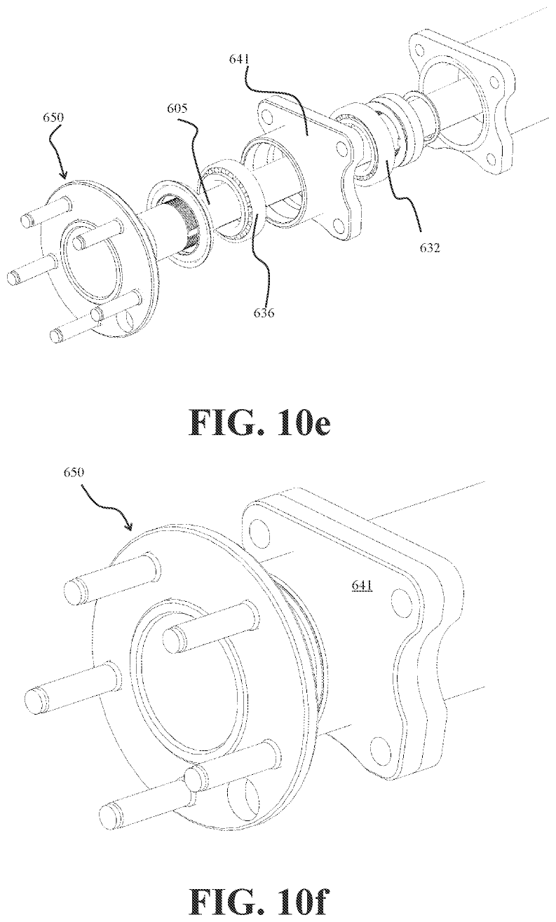

FIGS. 10a, 10b, and 10c show an exploded view of an exemplary improved axle assembly as described herein. FIG. 10a shows an exploded assembly view of the axle, hub, mounting plate, and bearing assembly. FIG. 10b shows an assembled (not exploded) view of the components in FIG. 10a.

FIG. 10d shows a rear elevated-angle view of an exemplary improved axle as disclosed herein. FIG. 10e shows a front elevated-angle exploded view of an exemplary improved axle as disclosed herein. FIG. 10f shows a front close-up elevate angle view of an exemplary improved axle as disclosed herein.

What is claimed is:

1. An axle assembly for a vehicle, comprising:
a shaft;
a hub comprising a hub flange; and
a bearing assembly;
wherein:
the hub flange comprises a front side and a back side;
when viewed from the front side, the hub flange is circular;
when viewed from the back side the hub flange is circular;
the front side of the hub flange faces away from the center of the vehicle;
the back side of the hub flange faces toward the center of the vehicle;
the hub flange has a first hole from the front side of the hub flange to the back side of hub flange;
the first hole is not located in the center of the hub flange;
the first hole is configured to accept a first piece of securing hardware comprising a substantially cylindrical body and a head on one end of the body;
the first hole is sized to allow the cylindrical body of the first piece of securing hardware head to pass, but to not allow the head of the securing hardware to pass; and
an imaginary circle having a center at the center of the circular hub flange, concentric with the circular shape of the hub flange as viewed from the front side or the back side; and having a radius that is the distance from the center of the circular hub flange to the point on the front side of the head of securing hardware that is nearest to the center of the circle passes through the hub flange.

2. The axle of claim 1, wherein the surface of a segment of the shaft is in mechanical force-transferring contact with an inner surface of the bearing assembly

3. The axle of claim 2, wherein the bearing assembly comprises dual tapered roller bearings.

4. The axle of claim 2, wherein the maximum diameter of the segment of the shaft in contact with the inner surface of the bearing assembly is greater than the minimum diameter of the shaft that is not in contact with the bearing assembly.

5. The axle of claim 4, wherein the diameter along the segment of the shaft in contact with the inner surface of the bearing assembly is uniform.

6. The axle of claim 5, wherein the diameter along the segment of the shaft in contact with the inner surface of the bearing assembly is 2.000 inches.

7. The axle of claim 4, wherein the minimum diameter of the axle segment not in contact with the bearing assembly is 1.510 inches.

8. The axle of claim 44, wherein the length of the segment of the shaft in contact with the bearing assembly is 2.630 inches.

9. The axle of claim 2, wherein the bearing assembly comprises straight roller bearings.

10. The axle of claim 1, wherein the back size of the hub flange is a convex curve from the bearing assembly to the outside edge of the hub flange.

11. The axle of claim 1, wherein the lip on the back side of the first hole is not a planar circle.
